(19) United States
(12) Patent Application Publication
(10) Pub. No.: US 2018/0056640 A1
(43) Pub. Date: Mar. 1, 2018

(54) 3D-OBJECT DATA PROCESSOR AND 3D-OBJECT DATA PROCESSING PROGRAM

(71) Applicant: Roland DG Corporation, Hamamatsu-shi (JP)

(72) Inventors: Makoto YOSHIDA, Hamamatsu-shi (JP); Akira HARADA, Hamamatsu-shi (JP)

(21) Appl. No.: 15/689,067

(22) Filed: Aug. 29, 2017

(30) Foreign Application Priority Data
Aug. 30, 2016 (JP) 2016-168043

(51) Int. Cl. B33Y 50/02; G06T 19/20; G06T 17/10

(52) U.S. Cl. CPC B33Y 50/02; B33Y 30/00; G06T 17/10; G06T 19/20

(57) ABSTRACT

To assist correction of three-dimensional modeled objects to be created using 3D printers.

The present invention provides a 3D-object data processor 1 including a storage unit 20 for storing 3D-object data 22 representing a three-dimensional modeled object to be created using a 3D printer, a display unit 50, means 12 for generating, based on the 3D-object data, slice data 23 representing shapes of profiles resulting from slicing the modeled object at a predetermined distance into layers; means 13 for examining, based on the generated slice data, whether the shapes are normal or abnormal, and storing, as disconnection layer data 24, slice data representing the shape(s) in which an abnormality has been detected; and means 60 for generating data of an image in which the modeled object is represented as a three-dimensional image and the disconnection layer represented based on the disconnection layer data is distinguishable and displaying the image on the display unit.

### TECHNICAL FIELD

The present invention relates to devices for processing 3D-object data representing three-dimensional modeled objects to be created using a 3D printer, and 3D-object data processing programs for making a computer process 3D-object data.

### BACKGROUND ART

3D printers create a three-dimensional modeled object (hereinafter, also referred to as a modeled object) by creating each flat solid figure for a single layer resulting from slicing a modeled object at a predetermined distance into layers, and accumulating such solid figures in the direction perpendicular to planes of slice. A modeling machine described in JP-A-2015-33825 is an example of 3D printers. This modeling machine projects light to a photosensitive resin material contained in a vat from the bottom to trace an outline perimeter and infill and cure the resin material on the vat floor into a solid figure for a single layer having a thickness of about 0.05-0.1 mm. Once a solid figure for a single layer is complete, it is moved up by one layer height to build the next solid figure for another single layer. In this way, the photo-modeling machine creates a final modeled object by successively accumulating solid figures.

Data based on which a modeled object (hereinafter, also referred to as 3D-object data) is produced can be generated using a computer system with software for generating 3D-object data on a hardware device such as a personal computer. Examples of the software for generating 3D-object data include 3D CAD software, 3D computer graphics software, and 3D CAM software having a function of controlling 3D printers. 3D-object data can also be generated by scanning an object to be modeled using a 3D scanner.

File formats for 3D-object data typically vary depending on the software used for generating the 3D-object data. This creates the necessity for the conversion of 3D-object data into polygon meshes in a predetermined file format in order to control 3D printers according to the 3D-object data and create modeled objects. Many of the software products just mentioned and other software products capable of processing 3D scanning data have a function of converting generated 3D-object data into a file format for drawing polygon meshes. Among file formats for drawing polygon meshes, the STL format is the de facto standard which describes polygon faceted surfaces as a series of triangle facets.

Since 3D printers create modeled objects as multi-layered structures each composed of accumulated flat solid figures, it is necessary to generate data for drawing contours of shapes of profiles resulting from slicing a polygon mesh (hereinafter, also referred to as slice data) into layers at a distance equal to a thickness of the aforementioned single layer, in order to create a modeled object using a 3D printer. The slice data is data based on which each flat solid figure to be created using a 3D printer is produced. 3D printers successively create flat slid figures in the designated order based on the slice data sequentially transferred from a computer system. Many 3D CAM software products have a function of generating slice data. If a software product for generating 3D-object data has no function of generating slice data, another software product called “slicer” is used. For example, JP-A-2016-88066 describes slice data generators that generate slice data from a polygon mesh with triangle faces and correct an abnormality of a polygon mesh. Furthermore, “ARM-10 User's Manual”, Roland DG Corporation (available on the Internet at http://download.rolanddg.jp/cs/3d/manual/ARM-10_USE_JP_R2.pdf; retrieved Aug. 17, 2016) describes instructions to operate a 3D printer similar to the modeling machine described in JP-A-2015-33825 as well as 3D CAM software for generating and correcting 3D-object data for modeled objects to be created using that 3D printer.

To create a modeled object using a 3D printer operated by a user who wants to create a modeled object or generate 3D-object data (hereinafter, also referred to as an operator), the 3D-object data for that modeled object is converted into a polygon mesh using, for example, the aforementioned computer system and slice data is generated from the polygon mesh. Slicing may, however, be failed, such as that a profile drawn by the slice data is produced with a shape having open edges rather than being formed as a closed figure, resulting in the generation of slice data representing a profile with an abnormal shape. Since each modeled object created using a 3D printer is a multi-layered structure made of flat solid figures each corresponding to a single layer, 3D printers cannot create a layer for the slice data representing a profile with an abnormal shape. The modeling machine described in JP-A-2015-33825 is of the type where modeled objects are built downward with each successive solid figure for a single layer “printed” on bottom of the previous solid figure. Accordingly, any layer that cannot be formed (hereinafter, also referred to as a disconnection layer) causes layer separation or splitting of the modeled object in the direction parallel to the plane of the solid figures.

A major cause for the generation of a disconnection layer is a conflict in topology of the polygon mesh. For example, each polygon mesh in STL format should meet conditions as a solid model in which two triangles share a single edge and inside and outside of each model can clearly be distinguished from each other. If, however, conflicts in topology occur such as that the adjacent two triangles do not share a single edge, an attempt to generate slice data by slicing an area with a conflict results in a failure of slicing at that area. Conflicts in topology may occur when polygon meshes are generated from scanned 3D data. For example, noises caused when an original model of the modeled object is scanned using a 3D scanner are reflected in the 3D-object data. Generation of polygon meshes based on the 3D-object data including noise components results in conflicts in topology such as production of an area of which inside and outside have been inverted due to the noise. Even with correct polygon meshes, slicing may be failed during the process of generating slice data.

Slice data generator described in JP-A-2016-88066 and 3D CAM software described in the “ARM-10 User's Manual” can automatically correct slide data for the areas with conflicts in topology. They can prevent separation of modeled objects in 3D printers of the type where modeled objects are built downward. Using the techniques described in these documents, accuracy would possibly be sacrificed for cases where very complex modeled objects are created. If a conflict in topology happens to occur at an area with a very complex shape and the area is automatically corrected, the area can be formed to have a shape different from its original shape. For example, when a denture to be molded by the lost wax method is formed using a 3D printer, the denture will not fit to complex profiles of teeth in a mouth of a patient due to even a minute difference in shape. It is not until the fabricated denture is worn by the patient that a problem is discovered. Since the profiles of the teeth change over time, any problem with the fabricated denture will lead to the fabrication process repeated again from the impression of the teeth.

Accordingly, for modeled objects having complex shapes, it may sometimes be desirable that a creator of the modeled objects (hereinafter, also referred to as an operator) corrects topologies around the profile of a cross section failed to be sliced by using, for example, a function of polygon mesh correction of 3D CAM software (hereinafter, also referred to a correction program). With conventional correction programs, however, it is difficult for operators to know the position of the area corresponding to abnormal slice data on the overall appearance of the modeled object and/or contours of shapes of correct profile of that area. In particular, it takes a lot of effort for the operator to correct when an area with a complex shape should be corrected.

Accordingly, an object of the present invention is to provide 3D data processors and 3D data processing programs which assist operators with their corrections of polygon meshes if three-dimensional modeled objects to be created using a 3D printer have an area that cannot be created, by making the operators to recognize in advance the exact position and the shape of the area that cannot be created.

### SUMMARY OF THE INVENTION

An aspect of the present invention to achieve the aforementioned object is a 3D-object data processor including:

a storage unit for storing 3D-object data representing a three-dimensional modeled object to be created using a 3D printer;

a display unit;

slice data-generating means for generating slice data based on the 3D-object data, the slice data representing shapes of profiles resulting from slicing the modeled object at a predetermined distance into layers;

disconnection layer-detecting means for examining, based on the generated slice data, whether the shapes are normal or abnormal, and storing, as disconnection layer data, slice data representing the shape(s) in which an abnormality has been detected; and

display control means for generating data of an image in which the modeled object is represented as a three-dimensional image and the disconnection layer represented based on the disconnection layer data is distinguishable and displaying the image on the display unit.

Another aspect of the present invention is a 3D-object data processing program for making a computer execute a method, the computer including a display unit and a storage unit having stored 3D-object data representing a three-dimensional modeled object to be created using a 3D printer, the method including:

a slice data-generating step for generating slice data based on the 3D-object data, the slice data representing shapes of profiles resulting from slicing the modeled object at a predetermined distance into layers;

a disconnection layer-detecting step for examining, based on the generated slice data, whether the shapes are normal or abnormal, and storing, as disconnection layer data, slice data representing the shape(s) in which an abnormality has been detected; and

a display control step for generating data of an image in which the modeled object is represented as a three-dimensional image and the disconnection layer represented based on the disconnection layer data is distinguishable and displaying the image on the display unit.

Other features of the present invention will be apparent from the description of the specification.

According to the present invention, if three-dimensional modeled objects to be created using a 3D printer have an area that cannot be created, an operator who creates a modeled object is allowed to recognize in advance the exact position and the shape of the area that cannot be created. This reduces operations of the operator to correct 3D-object data representing the modeled object. In addition, failures of creating modeled objects can be avoided. Other effects will be apparent in the following description.

### BRIEF DESCRIPTION OF THE DRAWINGS

FIG. 1 is a schematic view showing how slice data are generated by a 3D-object data processor according to an embodiment of the present invention;

FIG. 2 is a functional block diagram of the 3D-object data processor;

FIG. 3 is a flow chart showing a process to provide a preview function of the 3D-object data processor; and

FIG. 4 is a view showing an example of an image of a modeled object displayed on a display device using the preview function.

### DETAILED DESCRIPTION OF THE INVENTION

### Summary of the Disclosure

According to the description of the present specification, at least following features are provided. Provided is a 3D-object data processor comprising:
a storage unit for storing 3D-object data representing a three-dimensional modeled object to be created using a 3D printer;

a display unit;

slice data-generating means for generating slice data based on the 3D-object data, the slice data representing shapes of profiles resulting from slicing the modeled object at a predetermined distance into layers;

disconnection layer-detecting means for examining, based on the generated slice data, whether the shapes are normal or abnormal, and storing, as disconnection layer data, slice data representing the shape(s) in which an abnormality has been detected; and

display control means for generating data of an image in which the modeled object is represented as a three-dimensional image and the disconnection layer represented based on the disconnection layer data is distinguishable and displaying the image on the display unit. With such 3D-object data processor, if a three-dimensional modeled object to be created using a 3D printer has an area that cannot be formed, it is possible to make an operator recognize in advance the exact position and the shape of the area that cannot be formed. This reduces operations of the operator to correct 3D-object data representing the modeled object. In addition, failures of creating modeled objects can be avoided.

Also provided is the 3D-object data processor, wherein, in the image whose data is generated by the display control means, the modeled object is represented by accumulating solid figures each having a profile with a normal shape and a thickness equal to the predetermined distance, and a contour of a profile with an abnormal shape based on the disconnection layer data is represented by a line having a thickness of the predetermined distance. With such 3D-object data processor, an operator can easily recognize the overall appearance of a modeled object composed of solid figures each formed for a layer of a predetermined thickness having a shape of a profile resulting from slicing the modeled object at a predetermined distance by a 3D printer, the position of a layer that cannot be formed as a normal layer relative to the overall appearance, and shapes of the layers adjacent to that layer.

The 3D-object data processor may be the one wherein the modeled object is represented in an image generated based on the 3D-object data. Such 3D-object data processor eliminates processes of generating data for each solid figure based on the slice data and generating data for an overall appearance of the modeled object by accumulating the solid figures. As a result, it is expected that data processing for generating image data can be reduced and in turn, the time required for generating image data can be reduced.

Provided is the 3D-object data processor wherein data of the image in which an area corresponding to the discontinuous layer data is filled with a different color from an area corresponding to the slice data representing the profile(s) with the normal shape(s) is generated by the display control means. With such 3D-object data processor, it is possible to clearly indicate an area or a shape that cannot be created using a 3D printer to an operator. Operations to correct 3D-object data by the operators can further be reduced.

The 3D-object data processor may be the one wherein slice data representing the profile with the normal shape includes slice data representing a profile with a normal shape obtained by correcting a profile with an abnormal shape, and wherein data of an image in which an area corresponding to the corrected slice data is distinguishable is generated by the display control means. With such 3D-object data processor, for example, it is possible to make an operator recognize a corrected area in the modeled object and the operator can distinguish an area that has been normal and the corrected area when, for example, additional correction should be made.

Also provided is a 3D-object data processing program for making a computer execute a method, the computer comprising a display unit and a storage unit having stored 3D-object data representing a three-dimensional modeled object to be created using a 3D printer, the method comprising:

a slice data-generating step for generating slice data based on the 3D-object data, the slice data representing shapes of profiles resulting from slicing the modeled object at a predetermined distance into layers;

a disconnection layer-detecting step for examining, based on the generated slice data, whether the shapes are normal or abnormal, and storing, as disconnection layer data, slice data representing the shape(s) in which an abnormality has been detected; and

a display control step for generating data of an image in which the modeled object is represented as a three-dimensional image and the disconnection layer represented based on the disconnection layer data is distinguishable and displaying the image on the display unit. By installing such 3D-object data processing program on a computer, it is possible to make the computer function as the aforementioned 3D-object data processor.

Now, referring to the drawings, embodiments of the present invention are described below.

### Embodiments

A 3D-object data processor according to an embodiment of the present invention processes 3D-object data representing a 3D modeled object and generates slice data for drawing shapes of profiles resulting from slicing the modeled object at a predetermined distance into layers. It has a function (hereinafter, also referred to as a preview function) of examining whether the shapes are normal or abnormal by the analysis of the generated slice data as well as allowing an operator to distinguish a disconnection layer based on the slice data representing the shape(s) in which an abnormality has been detected (hereinafter, also referred to as disconnection layer data) on an image of the modeled object when a 3D image of the modeled object is displayed on a display device. The 3D-object data processor makes the operator easily recognize, from the image displayed using this preview function (hereinafter, also referred to as a preview image), the position of a disconnection layer relative to an overall appearance of the modeled object and a shape in the vicinity of the disconnection layer, thereby strongly assisting subsequent corrections of 3D-object data made by the operator. Generation of slice data and detection of a disconnection layer are described below, and then a configuration of the 3D-object data processor and a process of the preview function according to this embodiment are described.

<Generation of slice data>

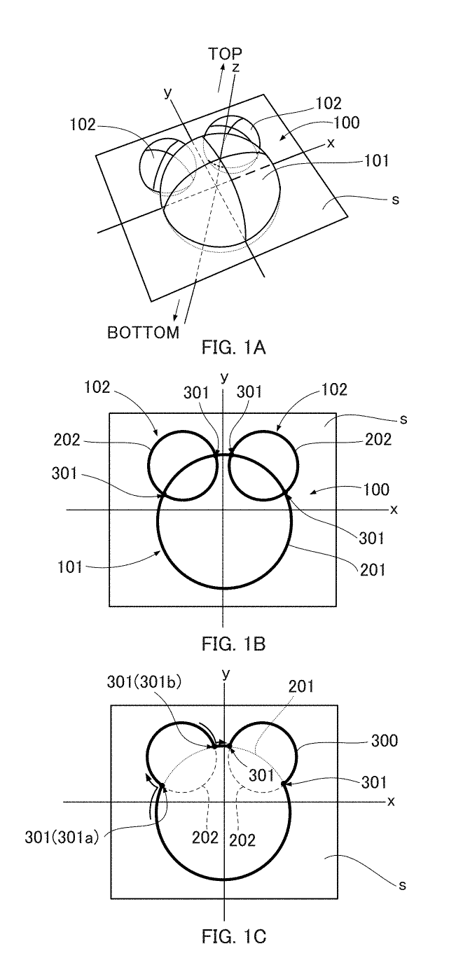

How slice data are generated from a polygon mesh is described with reference to FIG. 1. FIG. 1(A) shows an appearance of a modeled object whose shape is defined as a polygon mesh. FIG. 1(B) shows a profile of the modeled object shown in FIG. 1(A) resulting from slicing the modeled object along a predetermined plane (hereinafter, also referred to as a slice plane). FIG. 1(C) shows a contour of the profile shown in FIG. 1(B). In the following description, a Cartesian coordinate system is defined with by slice planes s oriented on x,y planes and the z-axis oriented parallel to the direction perpendicular to the slice planes. The z-coordinate of zero is located at either the lower or upper extremity of an area occupied by the modeled object.

As shown in FIG. 1(A), an exemplified modeled object 100 has a shape of a larger sphere 101 with two smaller spheres 102 connected to the larger one. The shape of the modeled object 100 including the inner surface of, for example, a cavity or a pore formed in or within the modeled object 100 is defined as a polygon mesh. With the z-coordinates of zero and Z located at the uppermost and lowermost ends of the modeled object 100, respectively, slice data is generated every time the modeled object 100 is sliced along a plane parallel to the x,y-plane at a predetermined distance (hereinafter, denoted as Δz) in the downward direction from the plane whose z-coordinate is zero to the plane whose z-coordinate is Z. The slice data represents shapes of profiles resulting from slicing the modeled object 100 as a multi-layered structure into layers accumulated along the z-axis direction. If a profile has no abnormality, that is, if slicing is complete successfully, this profile is represented as a closed figure bounded by a line or lines.

FIG. 1(B) shows a shape of a profile resulting from slicing the modeled object along an x,y-plane s which crosses the z-axis and includes points where the larger sphere 101 meets the smaller spheres 102. When the polygon mesh of the modeled object 100 is sliced along the x,y-plane s, the boundary of the circular section of the sphere 101 intersects the boundaries of the circular sections of the spheres 102 on the x,y-plane s. Intersections between the boundaries are correlated to each other based on topology of the polygon mesh of the unsliced modeled object 100. Specifically, the adjacent intersections are linked using a double linked list. As a result, contours (boundary polylines 201, 202) of three regular polygons that approximate circles corresponding to the circular sections of the three spheres (101, 102) are formed on the x,y-plane s. After the boundary polylines (201, 202) for the spheres are formed, the three boundary polylines (201, 202) are divided at the intersections 301 as shown in FIG. 1(C) to convert each of the closed boundary polylines (201, 202) of the circles into polylines with open ends at the intersections 301. The ends of the polyline at the intersections 301 are then connected to each other. The result is a boundary polyline 300 that bounds a merged combination of the three circles (201, 202). Data representing this boundary polyline 300 is used as slice data. In this example, as depicted by arrows in FIG. 1(C), when the boundary polyline 201 for the larger circle is followed in a predetermined direction and the path encounters an intersection 301a with the polyline 202 for one smaller circle, the path diverges to the boundary polyline for the smaller circle 202 at the intersection 301a. The path returns from the boundary polyline 202 for the smaller circle to the boundary polyline 201 for the larger circle at a next intersection 301b. In this way, the boundary polyline 300 defining the outline of the profile is formed. The slice data in this example represents a boundary polyline of a profile composed of two semicircles resting at different positions on a circumference of a large full circle.

<Detection of disconnection layer>

During the generation of the slice data described with reference to FIGS. 1(A) to 1(C), disconnection layer data can be generated for some reason. When the disconnection layer data is generated, a layer corresponding to that disconnection layer data is becomes as the disconnection layer and the layered modeled object splits at the disconnection layer. Possible causes for the disconnection layer are as follows. Any of the boundary polylines (201, 202) of the three circles in FIG. 1(B) is not closed. In other words, vertices that should be at the same position may have different coordinates in the double linked list describing relationships between the vertices that are connected to form the boundary polylines (201, 202). Alternatively, the both ends of a polyline may have different coordinates in the double linked list. If the two ends have the same coordinates but not correlated to each other in the double linked list, the polyline should be closed.

A disconnection layer may occur during the operation of merging polygons. For example, although two line segments intersect at the intersection 301 where the circles (201, 202) meet in FIG. 1(B), three or more line segments may intersect for some reason and the polyline tracing the outline perimeter of a shape of a profile may have a gap. In modeling machines of the type where modeled objects are built downward as described in JP-A-2015-33825, a modeled object can drop down due to its own weight during the building process for the modeled object. A support structure called “support” may be built along with the modeled object itself. Some software products for generating 3D-object data automatically create a polygon mesh including the support when converting 3D-object data into the polygon mesh. If this automatic creation of the support results in creation of two or more supports at the intersection between the two circles in FIG. 1(B), the contour of the profile cannot be traced along the path ahead of the intersection 301, producing a figure whose contour is defined by a boundary polyline with a gap or gaps after the circles are merged.

In this way, if slicing is failed during the process of generating slice data for a certain cross section, and boundary polylines of the figures making up the profile of the cross section or a boundary polyline of a figure produced by merging two or more figures have/has open ends, the layer failed to be sliced is considered as a disconnection layer and slice data for drawing the shape of the profile of that disconnection layer is considered as disconnection layer data.

For the purpose of facilitating the understanding of the features of the present invention, the processes of generating slice data and detecting a disconnection layer have been described above in conjunction with the simple modeled object shown in FIG. 1 used as an example. Details of the processes of generating slice data and detecting a disconnection layer can be found in, for example, JP-A-2016-88066.

<3D-object data processor>

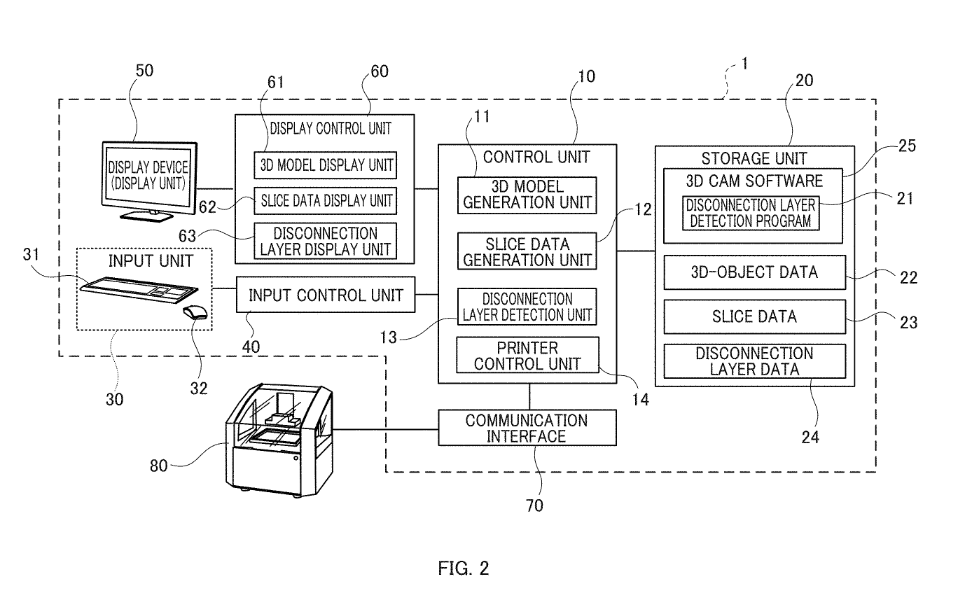

Next, an exemplified configuration of a 3D-object data processor according to an embodiment is described. The hardware for the 3D-object data processor may be achieved using, for example, a personal computer. The personal computer serves as the 3D-object data processor when executing a program (hereinafter, also referred to as a disconnection layer detection program) that has been installed on it. FIG. 2 shows an example of a 3D-object data processor 1 according to an embodiment of the present invention. In FIG. 2, structures and functions of the 3D-object data processor 1 are shown in blocks.

The 3D-object data processor 1 comprises a control unit 10 including a CPU, a RAM, and a ROM, a storage unit 20 including an external storage device such as a hard disk drive (HDD), an input unit 30 such as a keyboard 31 or a mouse 32, an input control unit 40 for transferring, to the control unit 10, input information corresponding to an operator input to the input unit 30, a display unit (hereinafter, also referred to as a display device 50), and a display control unit 60 that performs rendering of data describing objects (such as polygon meshes and line segments) as well as views/perspectives generated in the control unit 10 for displaying them on the display device 50. The illustrated 3D-object data processor 1 is connected to a 3D printer 80 via an appropriate communication interface (such as a USB interface) 70. It should be noted that the 3D-object data processor 1 is for assisting an operator with his or her correcting disconnection layer data by allowing him or her to check the position(s) and/or the shape(s) of a disconnection layer or layers, and the connection of the 3D printer 80 is thus merely an option herein.

The storage unit 20 stores a disconnection layer detection program 21 as described above and 3D-object data 22 representing a modeled object. The storage unit also stores slice data 23 and disconnection layer 24 generated by the control unit 10 executing the disconnection layer detection program 21. The disconnection layer detection program 21 in this embodiment can be achieved by a single program unit or a combination of program units included in 3D CAM software 25 as illustrated. The control unit 10 serves as a 3D model generation unit 11, a slice data generation unit 12, and a disconnection layer detection unit 13 when executing the disconnection layer detection program 21. The control unit 10 also serves as a printer control unit 14 that controls the 3D printer 80 via the communication interface 70 and directs the 3D printer 80 to create a modeled object.

The display control unit 60 has a VRAM and a predetermined display interface (such as HDMI (registered trademark)). The major functions of the display control unit 60 are: to render polygon meshes generated in the control unit 10, write them into the VRAM in the bitmap format, and present the bitmap images on the display device 50. The display control unit 60 can be achieved using, for example, a dedicated hardware component such as a graphic card. In the configuration shown in FIG. 2, the display control unit 60 serves as a 3D model display unit 61, a slice data display unit 62, and a disconnection layer display unit 63, depending on the type of image data for images to be displayed on the display unit 50. For example, the display control unit 60 provides a display of a stereo image of a modeled object obtained by 3D-rendering performed by the 3D model display unit 61, and also provides a display of 2D images representing profiles of the layers with normal and abnormal shapes by the slice data display unit 62 and the disconnection layer display unit 63, respectively. The control unit 10 provides a GUI environment for an operator who operates the 3D-object data processor 1. When an input from the input unit 30 is received via the input control unit 40, the control unit 10 processes data stored on the storage unit 20 according to the input and then directs the display control unit 60 to display an image for the processed result on the display device 50. In this way, images reflecting the input(s) from the operator are refreshed as appropriate and presented on the display device 50.

### <Preview Function>

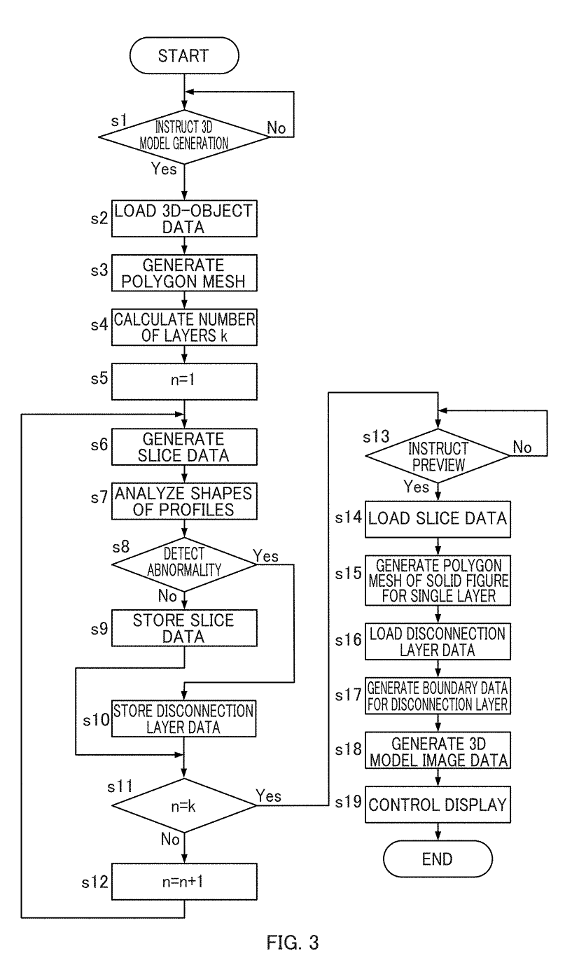

Next, a process to provide the preview function of the 3D-object data processor 1 having the aforementioned configuration is described. FIG. 3 shows a flow of this process. In response to a user input indicating an instruction of the process of 3D model generation for a modeled object, the 3D model generation unit 11 of the 3D-object data processor 1 generates a polygon mesh of the modeled object based on the 3D-object data 22 (from s1 to s2 and s3). The slice data generation unit 12 calculates the number k of the slices of the polygon mesh based on a size Z along the z-axis of an area occupied by the polygon mesh and a distance Δz at which the modeled object is sliced in the direction parallel to the xy-plane (s4). That is, the 3D printer builds first to k-th layers, with the layer built first at z=0 being considered as n=1. The slice data generation unit 12 slices the modeled object starting from the position having the z-coordinates of zero at a predetermined distance Δz into layers and generates slice data for drawing a shape of a profile of the first layer.

The disconnection layer detection unit 13 examines whether the shape of the profile drawn by the slice data is normal or abnormal upon generation of the slice data by the slice data generation unit 12. If slicing is complete successfully in response to the detection that the profile has a normal shape, that slice data 23 is correlated to the layer number n=1 of the current layer and stored on the storage unit 20 (from s5-s8 to s9). On the other hand, if slicing is failed, the generated slice data is stored on the storage unit 20 as the disconnection layer data 24 which is correlated to the layer number n=1 of the current layer (from s8 to s10). The amount of 1 is added to the current layer number n to examine whether slice data for the following layer has an abnormality or not (from s11 to s12, and then to s6). According to the detection result, the slice data 23 or the disconnection layer data 24 are successively stored on the storage unit 20 (from s7 and s8 to s9 or from s7 and s8 to s10).

In this way, the control unit 10 generates slice data for all layers (n=k) by the slice data generation unit 12 and the disconnection layer detection unit 13, examines whether the shapes of the profiles have an abnormality from the generated slice data, and stores the slice data 23 and the disconnection layer data 24 based on the detection results (from s7 and s8 to s9, from s11 to s13 or from s7 and s8 to s10 and s11 and then to s13). After the all layers have been examined on their abnormalities in slice data, the control unit 10 waits for an input received via the input unit 30 from an operator indicative of displaying a preview image. In response to the input entered via the input control unit 40 indicative of displaying a preview image, the 3D model generation unit 11 in the control unit 10 processes the stored slice data 23 and the stored disconnection layer data 24 to generate data representing the preview image (from s13 to s14 through s18).

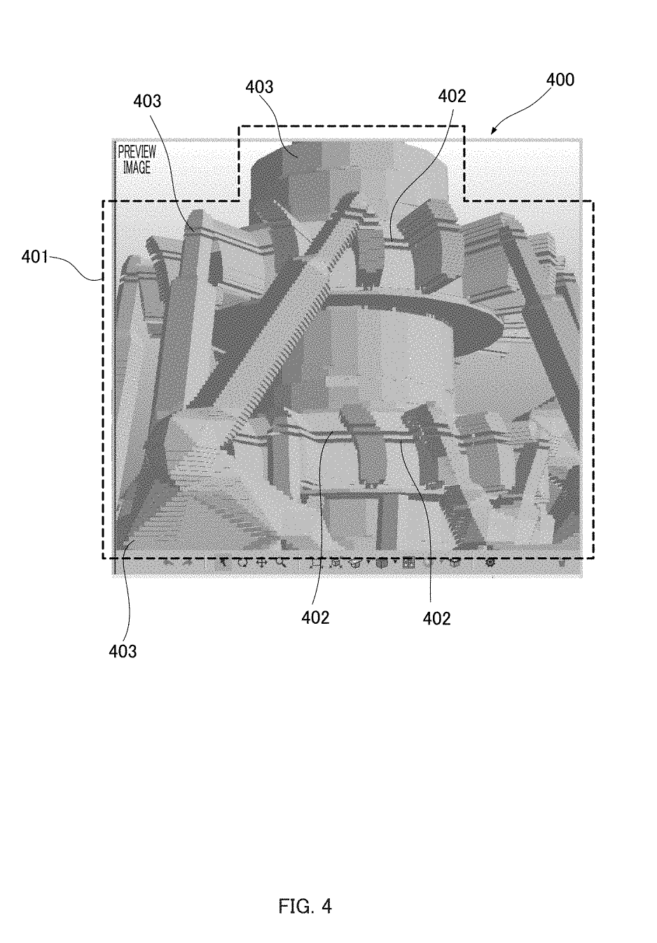

In this example, the 3D model generation unit 11 generates a polygon mesh for a solid figure having a shape whose profile corresponds to a boundary polyline and having a height equal to the thickness Δz for a single layer, based on the slice data 23 (s14 and s15). In addition, the 3D model generation unit 11 generates data for drawing a line segment defining a disconnection layer based on the disconnection layer data 24 (s16 and s17). In this example, the disconnection layers are drawn, in which the boundary polylines for the gapped contours represented by the disconnection layer data 24 are drawn with line segments having a thickness corresponding to the thickness Δz of a single layer. The display control unit 60 generates, by the 3D model display unit, an image data in which a line segment representing the disconnection layer is placed on the surface of the overall appearance of the modeled object made up of solid figures accumulated in the designated order at a position corresponding to the layer represented by the disconnection layer data 24 and displays, by the 3D model display unit 61, the image based on that image data as a preview image on the display device (s18 and s19). FIG. 4 shows an example of a preview image 400 for a modeled object 401 displayed on the display device 50. In this example, a disconnection layer 402 is displayed with a different color from a normal layer 403. Of course, the 3D-object data processor 1 displays, by the aforementioned GUI, images of the modeled object 401 on different scales or from different perspectives as well as images showing shapes of profiles of the layers 403 forming the modeled object 401 and the plane shape of the boundary polyline of the disconnection layer 402, depending on various input operations.

### Other Embodiments

In the 3D-object data processor according to the above embodiment, the normal layers are converted into flat polygon meshes and the resulting layers are accumulated to produce an image for the overall appearance of the modeled object in displaying the modeled object including a disconnection layer. An image of the modeled object, however, may be extracted using a polygon mesh representing the modeled object before the generation of the slice data and a polyline for a disconnection layer may be extracted in a distinguishable manner on that image.

The 3D-object data processor according to another embodiment of the present invention assists an operator with his or her correcting areas causing disconnection layer data in a polygon mesh of a modeled object. The operator thus corrects slice data so that the area of the disconnection layer is bounded by as a closed contour of a polyline or polylines by operating the 3D-object data processor and, for example, rearranging polygons on the image of the modeled object having the disconnection layer displayed on the display device. In displaying the modeled object on the display device, the corrected layer(s) may be distinguishable from the layers that have been normal. This allows the operator to distinguish the disconnection layer(s) from the corrected layers of the modeled object on the display device. If a layer that has been corrected is required to be re-corrected, the layer that should be re-corrected can easily be recognized.

Embodiments of the present invention are not limited to the modes achieved using computer systems as described above. They may be programs installed on general-purpose computers such as personal computers. The disconnection layer detection program in the above embodiment may be an embodiment of the present invention. The program may be stored on a portable recording medium (such as DVDs, CDs, USB memory devices, and memory cards) or provided on a website on the Internet in a downloadable manner.

The foregoing description of the embodiments has been provided examples and is not intended to limit the scope of the invention. The above configuration can be implemented in appropriate combinations, and various omissions, replacements, and changes can be made without departing from the essential features of the invention. The above embodiments and modifications thereof are included in the scope and spirit of the invention as well as within the invention described in the claims and their equivalents.

What is claimed is:

1. A 3D-object data processor comprising:
a storage unit for storing 3D-object data representing a three-dimensional modeled object to be created using a 3D printer;
a display unit;
slice data-generating means for generating slice data based on the 3D-object data, the slice data representing shapes of profiles resulting from slicing the modeled object at a predetermined distance into layers;
disconnection layer-detecting means for examining, based on the generated slice data, whether the shapes are normal or abnormal, and storing, as disconnection layer data, slice data representing the shape(s) in which an abnormality has been detected; and
display control means for generating data of an image in which the modeled object is represented as a three-dimensional image and the disconnection layer represented based on the disconnection layer data is distinguishable and displaying the image on the display unit.

2. The 3D-object data processor according to claim 1, wherein, in the image whose data is generated by the display control means, the modeled object is represented by accumulating solid figures each having a profile with a normal shape and a thickness equal to the predetermined distance, and a contour of a profile with an abnormal shape based on the disconnection layer data is represented by a line having a thickness of the predetermined distance.

3. The 3D-object data processor according to claim 1, wherein the modeled object is represented in an image generated based on the 3D-object data.

4. The 3D-object data processor according to claim 1, wherein data of the image in which an area corresponding to the discontinuous layer data is filled with a different color from an area corresponding to the slice data representing the profile(s) with the normal shape(s) is generated by the display control means.

5. The 3D-object data processor according to claim 1, wherein slice data representing the profile with the normal shape includes slice data representing a profile with a normal shape obtained by correcting a profile with an abnormal shape, and wherein data of an image in which an area corresponding to the corrected slice data is distinguishable is generated by the display control means.

6. A non-transitory computer readable medium including a 3D-object data processing program for making a computer execute a method, the computer comprising a display unit and a storage unit having stored 3D-object data representing a three-dimensional modeled object to be created using a 3D printer, the method comprising:
a slice data-generating step for generating slice data based on the 3D-object data, the slice data representing shapes of profiles resulting from slicing the modeled object at a predetermined distance into layers;
a disconnection layer-detecting step for examining, based on the generated slice data, whether the shapes are normal or abnormal, and storing, as disconnection layer data, slice data representing the shape(s) in which an abnormality has been detected; and
a display control step for generating data of an image in which the modeled object is represented as a three-dimensional image and the disconnection layer represented based on the disconnection layer data is distinguishable and displaying the image on the display unit.
